(19) United States
(12) Patent Application Publication
(10) Pub. No.: US 2018/0015608 A1
(43) Pub. Date: Jan. 18, 2018

(54) POCKET SCREWDRIVERS

(71) Applicant: Yong-Yue Cai, Nin-bo City (CN)

(72) Inventor: Yong-Yue Cai, Nin-bo City (CN)

(73) Assignee: Yong-Yue Cai

(21) Appl. No.: 15/210,592

(22) Filed: Jul. 14, 2016

(51) Int. Cl. B25G 1/08; B25B 15/02

(52) U.S. Cl. CPC B25G 1/085; B25B 15/02

(57) ABSTRACT

A pocket screwdriver includes a body, a rotary cassette, a pivot, a handle sleeve and a push rod. The body has a foundation, an accommodating chamber and a column, wherein the column has a storage groove for storing a screwdriver head. The rotary cassette is rotably installed in the accommodating chamber by the pivot, and has a plurality of cells for placing the screwdriver head. The handle sleeve can slide along a surface of the column to receive or expose the column. The push rod, fixed in the handle, is used for pushing or attracting the screwdriver head. When the pocket screwdriver is not in use, any one of the screwdriver heads placed in the plurality of cells can be stored in the storage groove, so that the handle sleeve can carry the push rod into the cell without the screwdriver head.

### BACKGROUND OF THE INVENTION

### 1. Field of the Invention

The present application relates to a head interchangeable screwdriver, and especially to a pocket screwdriver, which has a compact structure, and is easy to replace screwdriver head and convenient to carry.

### 2. The Prior Arts

There are many screws of various configurations installed in living environment and daily necessities, and screwdrivers are the most common hand tools used for rotating the screws, if the screws of one configuration shall need a screwdriver of corresponding type, too many types of the screwdrivers are not only inconvenient to use, but also difficult to store. In order to reduce the amount of the commonly used screwdrivers, there is a variety of head interchangeable screwdrivers available in current market.

U.S. Pat. No. 7,000,509 B2 discloses a screwdriver with a removable rotary bit receiving cassette. As shown in FIG. 1A, the screwdriver with a removable rotary bit receiving cassette includes a body 100, a cassette member 200, a shank 300, a handgrip 400, a retaining member 500, and an actuating member 600. The cassette member 200 is insertable through the opening to be rotatably mounted inside the body100. The shank 300 can move between a shaft hole 130 of the body 100 and a storage chamber 212 of the cassette member 200. The handgrip 400 is connected securely to the shank 30, and is in an engagement with the body 100. The retaining member 500 is mounted inside the body 100, and is capable of preventing rearward movement of the shank 300. The actuating member 600 is mounted inside the body 100, and is capable of timely pushing out the cassette member 200. To rotate the cassette member 200 can interchange different types of screwdriver heads 220 placed therein.

Although the screwdriver as shown in FIG. 1A can meet the purpose of interchanging head, the screwdriver head 220 of such screwdriver can be received in the cassette member 200 only at the shank 300 moving to the shaft hole 130 of the body 100. As shown in FIG. 1B, when the screwdriver is in carrying or not in use, the screwdriver head 200 keep in a status of sticking out a front segment 170 of the body 100 only depending on magnetic attraction of the shank 300. In such manner, the screwdriver is not only inconvenient to carry, but also the screwdriver head 170 probably detaches from the front segment 170. Therefore, it is still needed to further improve the current head interchangeable screwdriver.

### SUMMARY OF THE INVENTION

An aspect of the present application is to provide a pocket screwdriver including: a body, a rotary cassette, a pivot, a handle sleeve and a push rod. The body has a foundation, a column and an accommodating chamber interposed between the foundation and the column, wherein the foundation has a screwdriver head channel and a first pivot channel, the column has a push rod channel and a storage groove for storing a screwdriver head. The rotary cassette has a plurality of cells for placing screwdriver heads, and a second pivot channel, wherein the second pivot channel communicating the first pivot channel. The pivot runs through the first pivot channel and the second pivot channel, to rotatably install the rotary cassette in accommodating chamber, so that each the cell can communicate the screwdriver head channel and the push rod channel. The handle sleeve is capable of sliding along a surface of the column, to receive or expose the column. The push rod has a tail end and a magnetic head end, wherein the tail end is fixed in the handle sleeve; the magnetic head end sticks out the handle sleeve, and moves in push rod channel with the sliding of the handle sleeve, so as to push the screwdriver head into screwdriver head channel or to attract the screwdriver head into the cell.

In an embodiment, the screwdriver head has a bit and a polygonal shank, a shape of the screwdriver head channel corresponds to a shape of the polygonal shank, so as to prevent the screwdriver head occurs a rotation in the screwdriver head channel.

In an embodiment, the accommodating chamber has opposite a first side wall and a second side wall, and a semi-annular wall respectively connecting to the first side wall and the second side wall; a first through hole communicating the screwdriver head channel and a second through hole communicating the first pivot channel are formed in the first side wall; a third through hole communicating the push rod channel and a blind hole communicating the second pivot channel are formed in the second side wall; the semi-annular wall coordinates a surface profile of the rotary cassette; the semi-annular wall coordinates a surface profile of the rotary cassette; the pivot runs through the first pivot channel, the second through hole and the second pivot channel, and then embeds the blind hole, so as to rotably install the rotary cassette in the accommodating chamber.

In an embodiment, the rotary cassette has a recessed surface formed between two of the cells, a locator for coordinating the recessed surface is installed on the semi-annular wall; upon a rotation of the rotary cassette, the locator can clamp an outer surface of the cell by engaging the recessed surface, so as to allow the cell respectively align the first through hole and the third through hole, and then communicate the screwdriver head channel and the push rod channel.

In an embodiment, a type mark, corresponding to the screwdriver head placed in each the cell, is disposed on a surface of the rotary cassette, when the pocket screwdriver is in use, a desired screwdriver head can be selected by sliding the handle sleeve to expose the storage groove, and then rotating the rotary cassette according to the type mark.

In an embodiment, each the cell has an upper opening, an inner wall and a lower opening, the upper opening corresponds to a cross-sectional shape of the screwdriver head channel, the inner wall can prevent a rotation of the screwdriver head, and the lower opening corresponds to a cross-sectional shape of the push rod channel.

In an embodiment, a shape of the upper opening and a cross-sectional shape of the inner wall are polygonal, a shape of the lower opening is circle, and an aperture of the lower opening is less than an aperture of the upper opening.

In an embodiment, a stopper and a slot are disposed on the column, a bump is disposed in the handle sleeve, a recess is formed on the push rod, and a limiter is installed in the slot; upon the handle sleeve sliding to join the accommodating chamber, the bump engages the stopper to fix the handle sleeve; upon the handle sleeve sliding to expose the storage groove, the limiter engages the recess to prevent a separation of the handle sleeve and the column.

In an embodiment, a cross-sectional shape, perpendicular to the sliding direction of the handle sleeve, of the column is a non-circular shape, the handle sleeve is a hollow cylinder corresponding to a cross-sectional shape, perpendicular to the sliding direction of the handle sleeve, of the column, and the column has reinforcing ribs to prevent the handle sleeve rotating along the surface of the column.

In an embodiment, the pocket screwdriver of the present application further includes a head cover, which is installed on the foundation and joins a side of the accommodating chamber, having a top opening corresponding to the screwdriver head channel. When the handle sleeve completely receive the column and joins another side of the accommodating chamber, the head cover, the accommodating chamber, the rotary cassette and the handle sleeve constitutes a flush surface.

In the pocket screwdriver of the present application, the plurality of cells of the rotary cassette can place different types of the screwdriver heads, an user can select the type of screwdriver head based on demand; a storage groove is disposed in the column of the body, when the pocket screwdriver is not in use, any one of the screwdriver heads placed in the plurality of cells can be stored in the storage groove, so that the handle sleeve can completely receive the column, and then carry the push rod into the cell without the screwdriver head; accordingly, the pocket screwdriver of the present application can maintain its minimum size at a status of not exposing the screwdriver head, thus the objects of compact structure, easy to replace screwdriver head and convenient to carry can be achieved.

### BRIEF DESCRIPTION OF THE DRAWINGS

The present application can be understood in more detail by reading the subsequent detailed description in conjunction with the examples and references made to the accompanying drawings, in which:

FIGS. 1A and 1B schematically illustrate structures of a conventional head interchangeable screwdriver;

FIG. 2 is a cross-sectional exploded view schematically illustrating a pocket screwdriver according to an embodiment of the present application;

FIGS. 3A, 3B and 3C respectively are a front, top and rear views schematically illustrating the pocket screwdriver shown in FIG. 2;

FIGS. 4A, 4B and 4C respectively are cross-sectional, front and rear views schematically illustrating the rotary cassette of the pocket screwdriver shown in FIG. 2;

FIG. 5 is a front view schematically illustrating the handle sleeve and the push rod of the pocket screwdriver shown in FIG. 2; and

FIGS. 6 and 7 respectively are side views schematically illustrating using and carrying statuses of the pocket screwdriver of the present application.

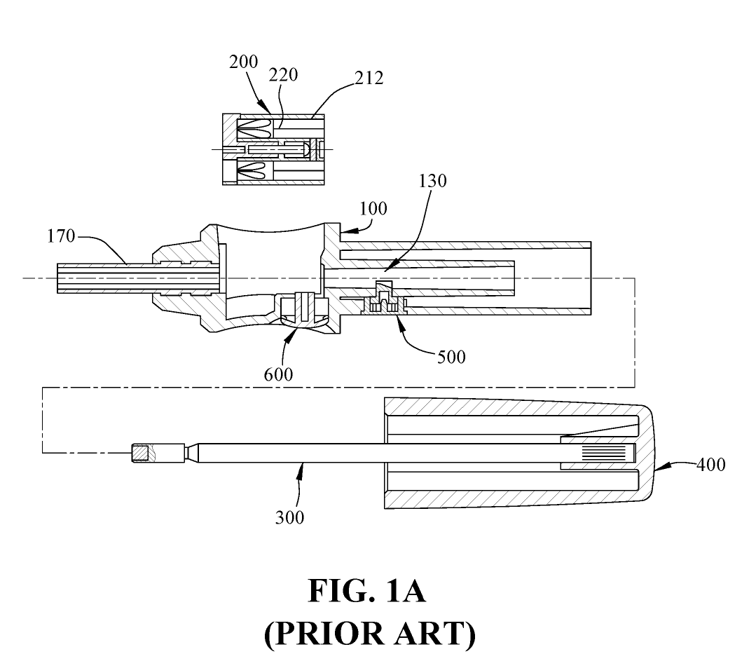

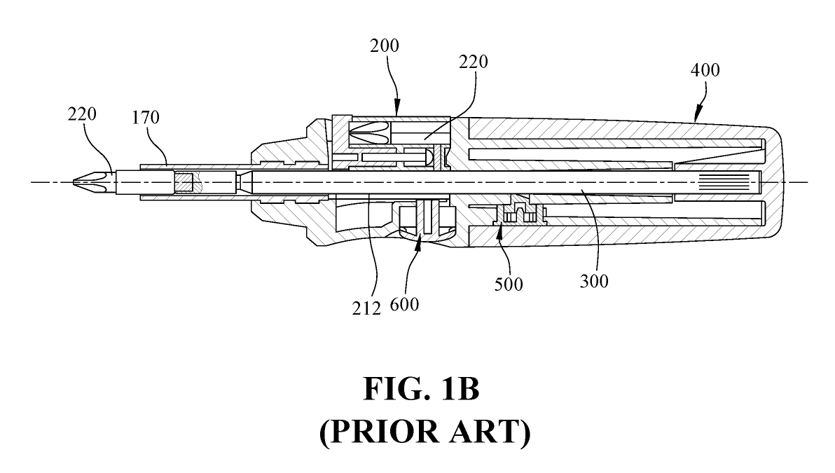

### DETAILED DESCRIPTION OF THE PREFERRED EMBODIMENTS

The present application may be embodied in various forms and the details of the preferred embodiments of the present application will be described in the subsequent content with reference to the accompanying drawings. The drawings (not to scale) show and depict only the preferred embodiments of the invention and shall not be considered as limitations to the scope of the present application. Modifications of the shape of the present application shall be considered to be within the spirit of the present application.

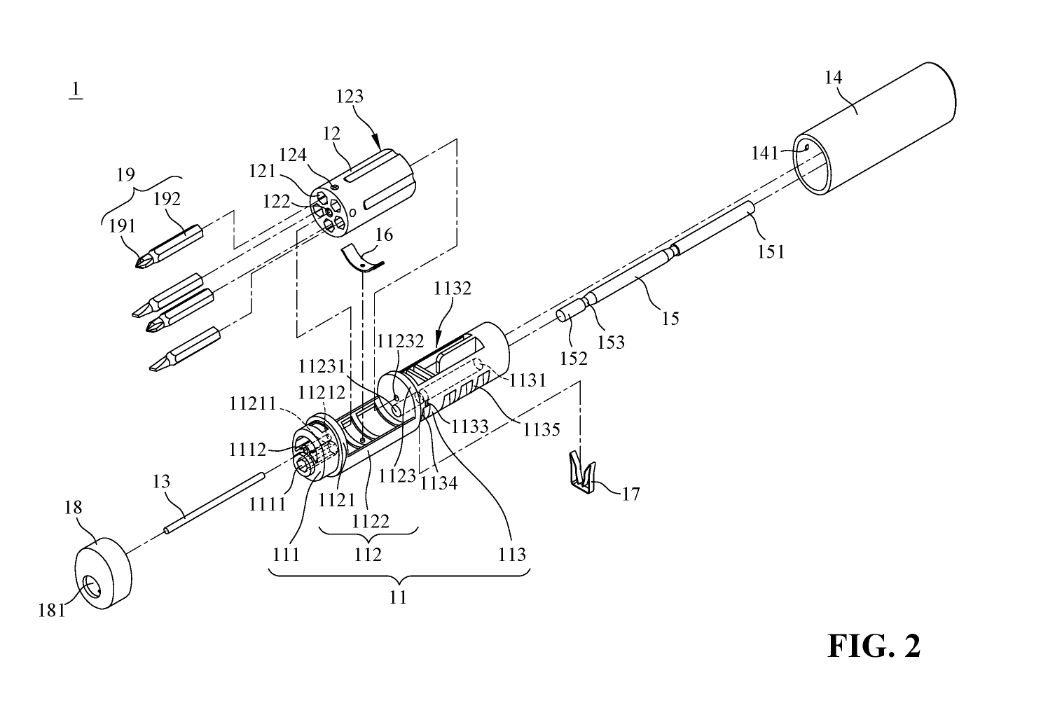

FIG. 2 is a cross-sectional exploded view schematically illustrating a pocket screwdriver according to an embodiment of the present application. As shown in FIG. 2, in this embodiment, a pocket screwdriver 1 includes a body 11, a rotary cassette 12, a pivot 13, a handle sleeve 14 and a push rod 15. The body 11 has a foundation 111, a column 113 and an accommodating chamber 112 interposed between the foundation 111 and the column 113, wherein the foundation 111 has a screwdriver head channel 1111 and a first pivot channel 1112, and the column 113 has a push rod channel 1131 and a storage groovel 132 for storing at least a screwdriver head 19.

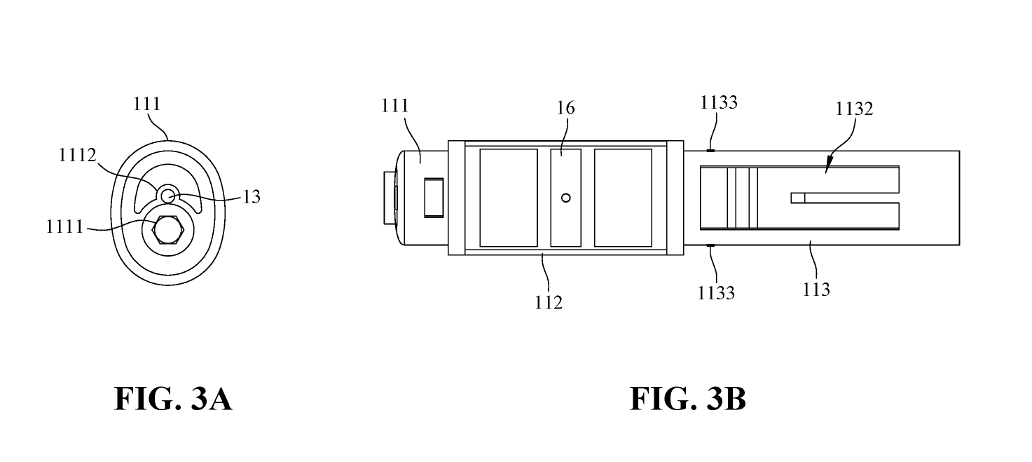

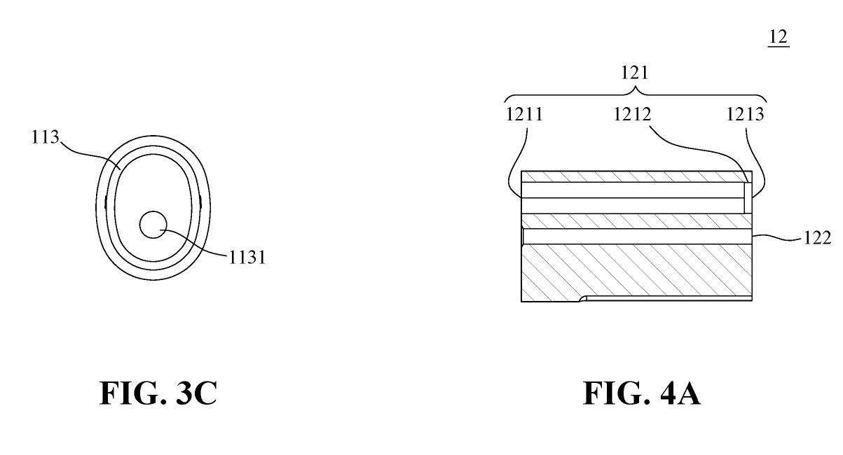

FIG. 3A is a front view schematically illustrating the pocket screwdriver shown in FIG. 2. As shown in FIGS. 2 and 3A, each screwdriver head 19 has a bit 191 and a polygonal shank 192. A type of the bit 191 is, for example but not limit to, Slotted, Phillips, Tamper proof, Triangle, Square recess, Hexagon. A type of the polygonal shank 192 is, for example but not limit to, Quadrangular, Pentagonal, Hexagonal, etc. In this embodiment, a shape of the screwdriver head channel 111 corresponds to the Hexagonal shank 192 of screwdriver head 19, to prevent the screwdriver head 19 rotate in the screwdriver head channel 1111, when the pocket screwdriver 1 is in use.

FIG. 3B is a top view schematically illustrating the pocket screwdriver shown in FIG. 2. As shown in FIGS. 2 and 3B, the accommodating chamber 112 has opposite a first side wall 1121 and a second side wall 1123, and a semi-annular wall 1122 respectively connecting to the first side wall 1121 and the second side wall 1122. A first through hole 11211 communicating the screwdriver head channel 1111 and a second through hole 11212 communicating the first pivot channel 1112 are formed in the first side wall. A third through hole 11213 communicating the push rod channel 1131 and a blind hole 11214 communicating the second pivot channel 122 are formed in the second side wall 123. An inner arc surface of the semi-annular wall 1122 coordinates a surface profile of the rotary cassette 12.

FIG. 3C is a rear view schematically illustrating the pocket screwdriver shown in FIG. 2. As shown in FIGS. 2 and 3C, a cross-sectional shape, perpendicular to the sliding direction of the handle sleeve, of the column is a non-circular shape (e.g. ellipse, polygon, etc.). In this embodiment, a cross-sectional shape of the column 113 is substantial ellipse, and the handle sleeve 14 is a hollow elliptical cylinder corresponds to the cross-sectional shape of the column 113. A cross-sectional shape, perpendicular to the sliding direction of the push rod 15, of the push rod channel 1131 is circular.

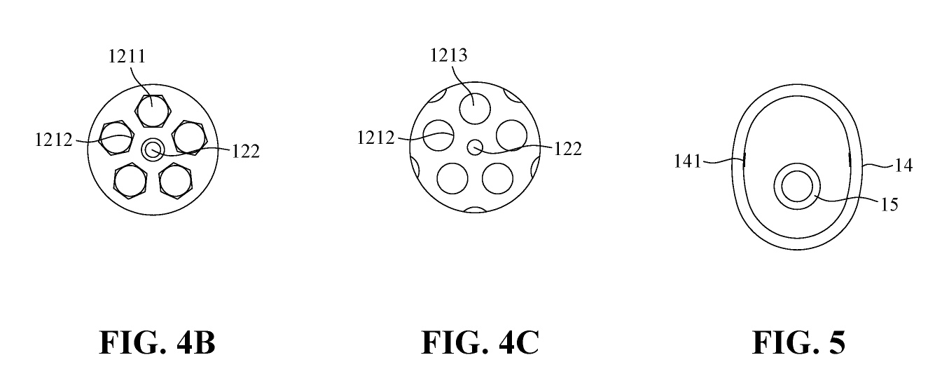

FIG. 4A is a cross-sectional view schematically illustrating the rotary cassette of the pocket screwdriver shown in FIG. 2. As shown in FIGS. 2 and 4A, the rotary cassette 12 has a plurality of cells 121 for placing the screwdriver heads 19, and a second pivot channel 122. An amount of the cells is, for example but not limit to, 5. The second pivot channel 122 communicates the first pivot channel 1112 through the second through hole 11212. After the rotary cassette 12 is placed in the accommodating chamber 112, the pivot 13 runs through the first pivot channel 1112, the second through hole 11212 and the second pivot channel 122, and then embeds the blind hole 11232, to rotably and interchangeably install the rotary cassette 12 in the accommodating chamber 112.

The rotary cassette 12 has a recessed surface 123 formed between two of the cells 121, and a locator 16 for coordinating the recessed surface 123 is installed on the semi-annular wall 122. Upon a rotation of the rotary cassette 12, the locator 16 can clamp an outer surface of the cell 121 by engaging the recessed surface 123, so as to allow the cell 121 respectively align the first through hole 11211 and the third through hole 11213, and then communicate the screwdriver head channel 1111 and the push rod channel 1121.

In order to facilitate a selection of the type of the screwdriver head 19, a type mark 124 (e.g. Slotted, Phillips, Tamper proof, etc.), corresponding to the screwdriver head 19 placed in each the cell 121, is disposed on a surface of the rotary cassette 12. When the pocket screwdriver 1 is in use, a desired screwdriver head 19 can be selected by sliding the handle sleeve 14 to expose the storage groove 1132, and then rotating the rotary cassette 12 according to the type mark 124. It is worthy to mentioned that an undetermined type mark 124 can be disposed thereon, the cell 121 corresponding to the undetermined type mark 124 can be used to place a special type of the screwdriver head 19 (e.g. Quadrangular, Pentagonal, Hexagonal, etc.), so as to increase an application range of the pocket screwdriver 1.

FIG. 4B is a front view schematically illustrating the rotary cassette of the pocket screwdriver shown in FIG. 2, FIG. 4C is a rear view schematically illustrating the rotary cassette of the pocket screwdriver shown in FIG. 2. As shown in FIGS. 4B and 4C, each the cell 121 has an upper opening 1211, an inner wall 1212 and a lower opening 1213. The upper opening 1211 corresponds to a cross-sectional shape of the screwdriver head channel 1111. The inner wall 1212 can prevent a rotation of the screwdriver head 19. The lower opening 1213 corresponds to a cross-sectional shape of the push rod channel 1131. Cross-sectional shapes of the upper opening 1211 and the inner wall 1212 are polygonal (e.g. Hexagonal, but not limit thereto). A cross-sectional shape of the lower opening 1213 is, for example but not limit to, circular, and an aperture of the lower opening 1213 is less than an aperture of the upper opening 1211. Accordingly, the screwdriver head 19 can enter or leave the cell 121 only by the upper opening 1211.

FIG. 5 is a front view schematically illustrating the handle sleeve and the push rod of the pocket screwdriver shown in FIG. 2. As shown in FIGS. 2 and 5, the handle sleeve 14 can slide along the surface of the column 131, then receive or expose the column 131. The push rod 15 has a tail end 151 and a magnetic head end 152, wherein the tail end 151 is fixed in the handle sleeve 14; the magnetic head end 152 sticks out the handle sleeve 14, and moves in push rod channel 1111 with the sliding of the handle sleeve 14, so as to push the screwdriver head 19 of metal material into a working position at the screwdriver head channel 1111, or to attract the screwdriver head 19 of metal material into a placing position at the cell 121.

A stopper 1133 and a slot 1134 are disposed on the column 113. A bump 141 is disposed in the handle sleeve 14. A recess 153 is formed on the push rod15. A limiter 17 is installed in the slot134. Upon the handle sleeve 14 sliding to completely receive the column 113 and join the accommodating chamber 112, the bump 141 engages the stopper 1133 to fix the handle sleeve 14; upon the handle sleeve 14 sliding to expose the storage groove 1132, the limiter 17 engages the recess 153 to prevent a separation of the handle sleeve 14 and the column 113.

The handle sleeve 14 is a hollow non-circular cylinder (e.g. hollow elliptical cylinder) corresponding to a cross-sectional shape (perpendicular to the sliding direction of the handle sleeve 14) of the column 113, and the column has reinforcing ribs 1135, to prevent that the pocket screwdriver 1 cannot work due to the handle sleeve 14 rotating along the surface of the column 113.

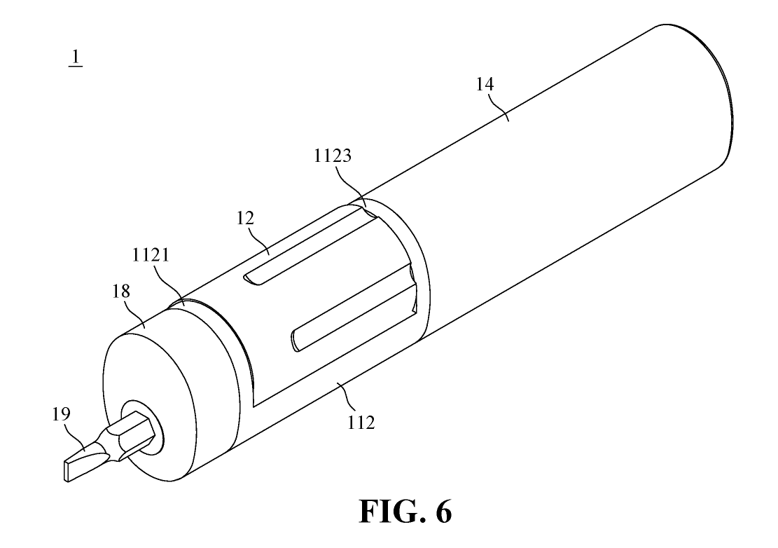

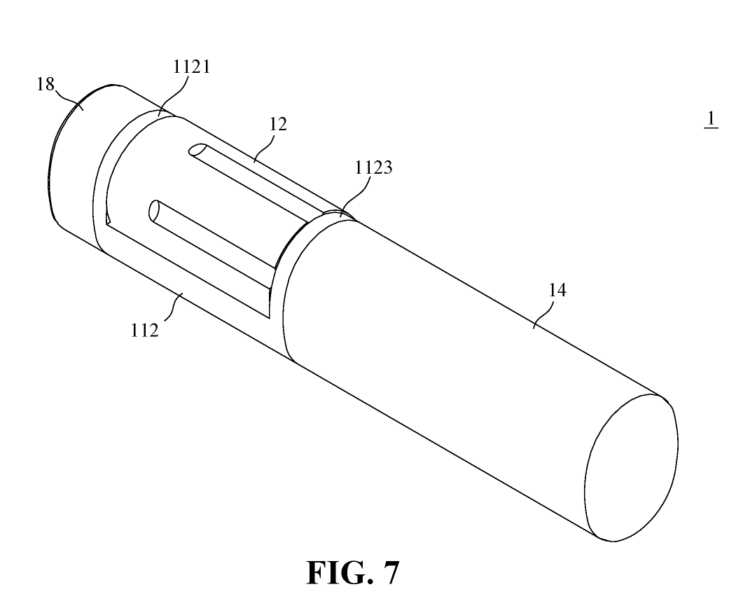

FIGS. 6 and 7 respectively are side views schematically illustrating using and carrying statuses of the pocket screwdriver of the present application. As shown in FIGS. 2 and 6, the pocket screwdriver 1 further includes a head cover 18, which is installed on the foundation 111 and joins the first side wall 1121 of the accommodating chamber 112. The head cover 18 has a top opening 181 corresponding to the screwdriver head channel 1111, and the screwdriver head 19 can run through the top opening 181. As shown in FIGS. 2 and 7, when the pocket screwdriver 1 is not in use, a user can store any one of the screwdriver heads 19 placed in the plurality of cells 121 (e.g. the cell 121 of undetermined type mark) in the storage groove 1132. When the handle sleeve 14 completely receive the column 113 and joins the second side wall 1123 of the accommodating chamber 112, then carry the magnetic head end 152 of the push rod 15 into the cell 121 without the screwdriver head 19, the head cover 18, the accommodating chamber 112, the rotary cassette 12 and the handle sleeve 14 constitutes a flush surface; for example, a configuration of the pocket screwdriver 1 is an elliptical cylinder. Accordingly, the pocket screwdriver 1 of the present application can maintain its minimum size at a status of not exposing the screwdriver head 19, thus the object of convenient to carry can be achieved.

In summary, in the pocket screwdriver of the present application, the plurality of cells of the rotary cassette can place different types of the screwdriver heads, an user can select the type of screwdriver head based on demand; a storage groove is disposed in the column of the body, when the pocket screwdriver is not in use, any one of the screwdriver heads placed in the plurality of cells can be stored in the storage groove, so that the handle sleeve can completely receive the column, and then carry the push rod into the cell without the screwdriver head; accordingly, the pocket screwdriver of the present application can maintain its minimum size at a status of not exposing the screwdriver head, thus the objects of compact structure, easy to replace screwdriver head and convenient to carry can be achieved.

Although the present application has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A pocket screwdriver, comprising:
a body, having a foundation, a column and an accommodating chamber interposed between the foundation and the column, wherein the foundation has a screwdriver head channel and a first pivot channel, the column has a push rod channel and a storage groove for storing a screwdriver head;
a rotary cassette, having a plurality of cells for placing screwdriver heads, and a second pivot channel, wherein the second pivot channel communicating the first pivot channel;
a pivot, running through the first pivot channel and the second pivot channel, to rotatably install the rotary cassette in accommodating chamber, so that each the cell can communicate the screwdriver head channel and the push rod channel;
a handle sleeve, capable of sliding along a surface of the column, to receive or expose the column; and
a push rod, having a tail end and a magnetic head end, wherein the tail end is fixed in the handle sleeve; the magnetic head end sticks out the handle sleeve, and moves in push rod channel with the sliding of the handle sleeve, so as to push the screwdriver head into screwdriver head channel or to attract the screwdriver head into the cell;
when the pocket screwdriver is not in use, any one of the screwdriver heads placed in the plurality of cells can be stored in the storage groove, so that the handle sleeve can completely receive the column, and then carry the push rod into the cell without the screwdriver head.

2. The pocket screwdriver according to claim 1, wherein the screwdriver head has a bit and a polygonal shank, a shape of the screwdriver head channel corresponds to a shape of the polygonal shank, so as to prevent the screwdriver head occurs a rotation in the screwdriver head channel.

3. The pocket screwdriver according to claim 1, wherein the accommodating chamber has opposite a first side wall and a second side wall, and a semi-annular wall respectively connecting to the first side wall and the second side wall; a first through hole communicating the screwdriver head channel and a second through hole communicating the first pivot channel are formed in the first side wall; a third through hole communicating the push rod channel and a blind hole communicating the second pivot channel are formed in the second side wall; the semi-annular wall coordinates a surface profile of the rotary cassette; the pivot runs through the first pivot channel, the second through hole and the second pivot channel, and then embeds the blind hole, so as to rotably install the rotary cassette in the accommodating chamber.

4. The pocket screwdriver according to claim 3, wherein the rotary cassette has a recessed surface formed between two of the cells, a locator for coordinating the recessed surface is installed on the semi-annular wall; upon a rotation of the rotary cassette, the locator can clamp an outer surface of the cell by engaging the recessed surface, so as to allow the cell respectively align the first through hole and the third through hole, and then communicate the screwdriver head channel and the push rod channel.

5. The pocket screwdriver according to claim 1, wherein a type mark, corresponding to the screwdriver head placed in each the cell, is disposed on a surface of the rotary cassette, when the pocket screwdriver is in use, a desired screwdriver head can be selected by sliding the handle sleeve to expose the storage groove, and then rotating the rotary cassette according to the type mark.

6. The pocket screwdriver according to claim 1, wherein each the cell has an upper opening, an inner wall and a lower opening, the upper opening corresponds to a cross-sectional shape of the screwdriver head channel, the inner wall can prevent a rotation of the screwdriver head, and the lower opening corresponds to a cross-sectional shape of the push rod channel.

7. The pocket screwdriver according to claim 6, wherein a shape of the upper opening and a cross-sectional shape of the inner wall are polygonal, a shape of the lower opening is circle, and an aperture of the lower opening is less than an aperture of the upper opening.

8. The pocket screwdriver according to claim 1, wherein a stopper and a slot are disposed on the column, a bump is disposed in the handle sleeve, a recess is formed on the push rod, and a limiter is installed in the slot; upon the handle sleeve sliding to join the accommodating chamber, the bump engages the stopper to fix the handle sleeve; upon the handle sleeve sliding to expose the storage groove, the limiter engages the recess to prevent a separation of the handle sleeve and the column.

9. The pocket screwdriver according to claim 8, wherein a cross-sectional shape, perpendicular to the sliding direction of the handle sleeve, of the column is a non-circular shape, the handle sleeve is a hollow cylinder corresponding to a cross-sectional shape, perpendicular to the sliding direction of the handle sleeve, of the column, and the column has reinforcing ribs to prevent the handle sleeve rotating along the surface of the column.

10. The pocket screwdriver according to claim 8, further comprising: a head cover, installed on the foundation and joining a side of the accommodating chamber, and having a top opening corresponding to the screwdriver head channel; when the handle sleeve completely receive the column and joins another side of the accommodating chamber, the head cover, the accommodating chamber, the rotary cassette and the handle sleeve constitutes a flush surface.
